(19) United States
(12) Patent Application Publication
(10) Pub. No.: US 2002/0041392 A1
(43) Pub. Date: Apr. 11, 2002

(54) Image output apparatus and image output method

(76) Inventor: Yutaka Tokura, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/955,136

(22) Filed: Sep. 19, 2001

(30) Foreign Application Priority Data
Sep. 19, 2000 (JP) 282758/2000
Sep. 17, 2001 (JP) 281769/2001

(51) Int. Cl. B41J 1/00

(52) U.S. Cl. 358/1.15

(57) ABSTRACT

Each output page is distributed to a printer which can color-output a job of a plurality of pages in which color output pages and B/W output pages exist mixedly and to a printer which can monochromatically output such a job, thereby efficiently executing a page outputting process in which an ejecting unit is effectively resource-utilized. Color output information and paper ejecting process resource information are obtained from each image processing apparatus. When a series of jobs in which B/W output pages and color output pages exist mixedly and which is requested from each host computer is received, a main controller analyzes the received series of jobs and distributes and outputs each page to a plurality of image processing apparatuses having different image processing functions on the basis of the obtained color output information and paper ejecting process resource information.

### BACKGROUND OF THE INVENTION

1. Field of the Invention

The invention relates to a server apparatus connected to a plurality of host computers and a plurality of image processing apparatuses having different image processing functions and different ejection processing functions through a network, an image processing apparatus for controlling a printer to which a paper ejecting unit which can communicate with the server apparatus can be attached, a data processing method, and a memory medium.

2. Related Background Art

In recent years, a print system for distributing and outputting a print job to a plurality of printers has been proposed.

For example, there has been proposed a print system constructed in a manner such that in case of a print job in which monochromatic (black/white: hereinafter, simply referred to as “B/W”) pages and color pages exist mixedly, the print job is distributed to a B/W printer with respect to the B/W pages and distributed to a color printer with respect to the color pages, respectively, and those pages are outputted in parallel.

According to such a print system, an occupation time of each printer can be reduced.

According to such a print system, however, since the B/W pages and the color pages are respectively outputted as a bundle of one set, there is a problem such that the user has to do work for rearranging a page order.

Since the user also has to do work for rearranging sheets printed by each of the color printer and the B/W printer in the page order, it is troublesome.

Particularly, in case of printing a large quantity of sheets, a time which is required for the manual work of the user is also considerably long. Therefore, it is demanded to save such a time with respect to the above problem.

### SUMMARY OF THE INVENTION

The invention is made to solve the above problems and it is an object of the invention that in case of distributing a print job to a plurality of printers and outputting printed sheets, a burden on the user at the time when he does work for rearranging the distributed and outputted sheets is reduced.

According to the first aspect of the invention, there is provided a server apparatus connected to a plurality of host computers and a plurality of image processing apparatuses having different image processing functions and different ejection processing functions through a network, comprising: obtaining means (corresponding to a main controller 102 shown in FIG. 1) for obtaining color output information and paper ejecting process resource information from each of the image processing apparatuses; receiving means (corresponding to a communication controller 101 shown in FIG. 1) for receiving a series of jobs in which B/W output pages and color output pages exist mixedly and which is requested by each of the host computers; and control means (corresponding to the main controller 102 shown in FIG. 1) for analyzing the series of jobs received by the receiving means, distributing an output of each page on the basis of the color output information and the paper ejecting process resource information which were obtained by the obtaining means to the plurality of image processing apparatuses having the different image processing functions, and outputting the pages.

The above and other objects and features of the present invention will become apparent from the following detailed description and the appended claims with reference to the accompanying drawings.

### BRIEF DESCRIPTION OF THE DRAWINGS

FIG. 1 is a block diagram showing a construction of an image forming system including image processing apparatuses and a server apparatus according to an embodiment of the invention:

FIG. 2 is a block diagram showing a detailed construction of the image processing apparatus shown in FIG. 1;

FIG. 3 is a schematic diagram showing an example of a paper ejector shown in FIG. 1;

FIG. 4 is a schematic diagram showing an example of a paper ejector shown in FIG. 1:

FIG. 5 is a flowchart showing an example of a data processing procedure in an information processing apparatus according to the invention;

FIG. 6 is a flowchart showing an example of the data processing procedure in the image processing apparatus shown in FIG. 1;

FIGS. 7A, 7B, and 7C are diagrams for explaining distribution of image data by a print server shown in FIG. 1 and an image output processing state by the paper ejector connected to each printer:

FIGS. 8A, 8B, and 8C are diagrams for explaining distribution of image data by the print server shown in FIG. 1 and an image output processing state by the paper ejector connected to each printer:

FIG. 9 is a diagram for explaining a memory map in a memory medium for storing various data processing programs which can be read out by an image processing system to which the server apparatus and image processing apparatus according to the invention can be applied; and

FIG. 10 is a flowchart showing the operation of a print server 100 in the second embodiment of the invention.

### DETAILED DESCRIPTION OF THE PREFERRED EMBODIMENTS

### First Embodiment

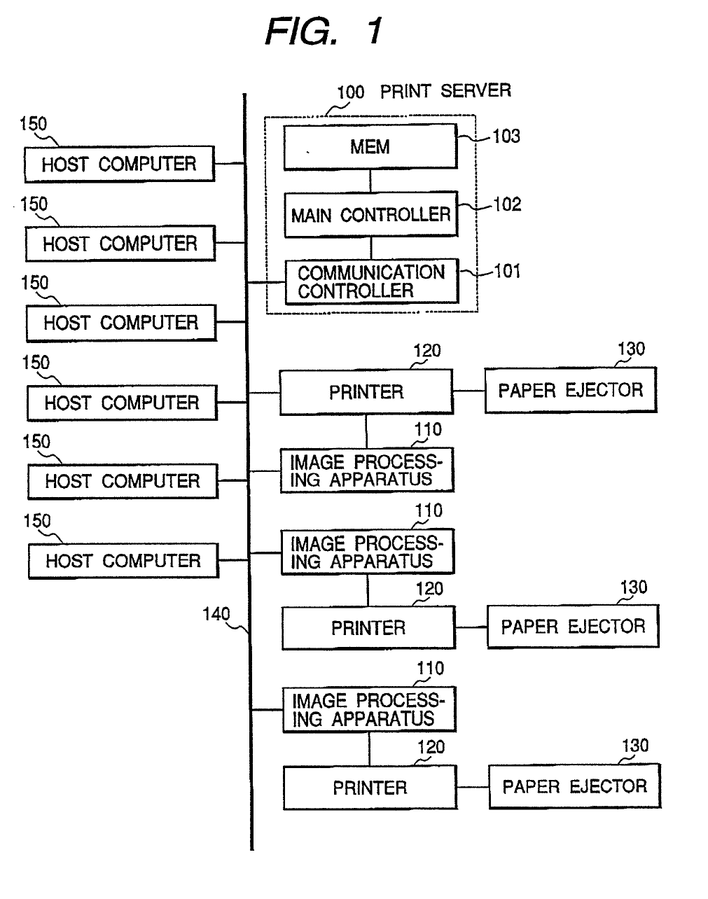

FIG. 1 is a block diagram showing a construction of an image processing system including image processing apparatuses and a server apparatus according to an embodiment of the invention. In the image processing system shown in the embodiment, one or a plurality of host computers 150 and a plurality of image processing apparatuses 110 are connected through an arbitrary network 140. The image processing system corresponds to a system in which a print server 100 having a bidirectional interface with each of the above apparatuses is connected to the network 140.

In FIG. 1, the print server 100 is connected to one or a plurality of host computers 150 through the network 140 by a communication controller 101 as shown in FIG. 1. The communication controller 101 receives print data which is transmitted from the host computers 150.

Reference numeral 102 denotes a main controller for temporarily storing the print data into a memory 103. With respect to a plurality of print data stored in the memory 103, the main controller 102 performs a control for sequentially reading the print data and distributing them to each image processing apparatus 110 on the basis of information of the print data. The communication controller 101 sends each print data to the image processing apparatus 110 designated by the main controller 102.

Reference numeral 120 denotes a printer to which a paper ejector 130 such as a sorter is attached. The sorter has a sorting function for ejecting printed sheets to a different bin every number of sheets and a grouping function for ejecting the printed sheets of the same page to the same bin. As other functions, there are a staple function and the like.

The paper ejector 130 realizes a function such as shift, staple, sort, group, booklet binding, punch, or the like through a printer interface 118, which will be explained hereinlater, similar to an interface provided between the printer 120 and image processing apparatus 110.

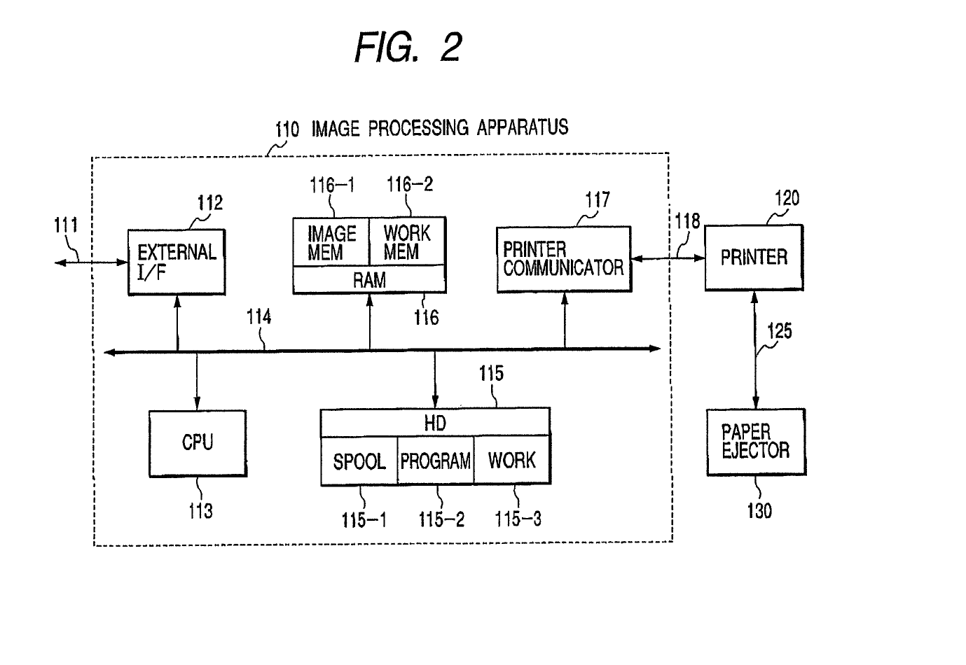

FIG. 2 is a block diagram showing a detailed construction of the image processing apparatus shown in FIG. 1 and the same component elements as those in FIG. 1 are designated by the same reference numerals.

The image processing apparatus 110 is connected to one or a plurality of host computers 150 and the print server 100 through an interface 111 such as a network or the like.

Reference numeral 113 denotes a CPU for performing a control such that the print data transmitted from one or a plurality of host computers 150 and the print server 100 through the interface 111 and an external interface circuit (external interface) 112 is temporarily stored into a spool area 115-1 provided in a hard disk 115, or the like.

The CPU 113 generates image data from the print data read out from the spool area 115-1 and writes it into an image memory 116-1 provided in an RAM 116. After that, the generated image data is read out from the image memory 116-1 and sent to the printer 120 via a printer interface (printer communicator) 117, so that a visible image is formed.

In the hard disk 115, a program area 115-2 is used for storing a program. The program in the program area 115-2 is transferred into a work memory 116-2 in the RAM 116 and executed by the CPU 113. A part of the work memory 116-2 in the RAM 116 and a work area 115-3 in the hard disk 115 are used as temporary work areas when the CPU 113 executes various controls. A CPU bus 114 connects each component element in the image processing apparatus 110 mentioned above.

The image data is generated every page from the print data stored in the spool area 115-1 in the hard disk 115. The print data of each page which is generated as image data is transferred once into the work memory 116-2 in the RAM 116 from the spool area 115-1 in the hard disk 115 by the CPU 113 and subjected to a generating process. The image date is written into the image memory 116-1 in the RAM 116.

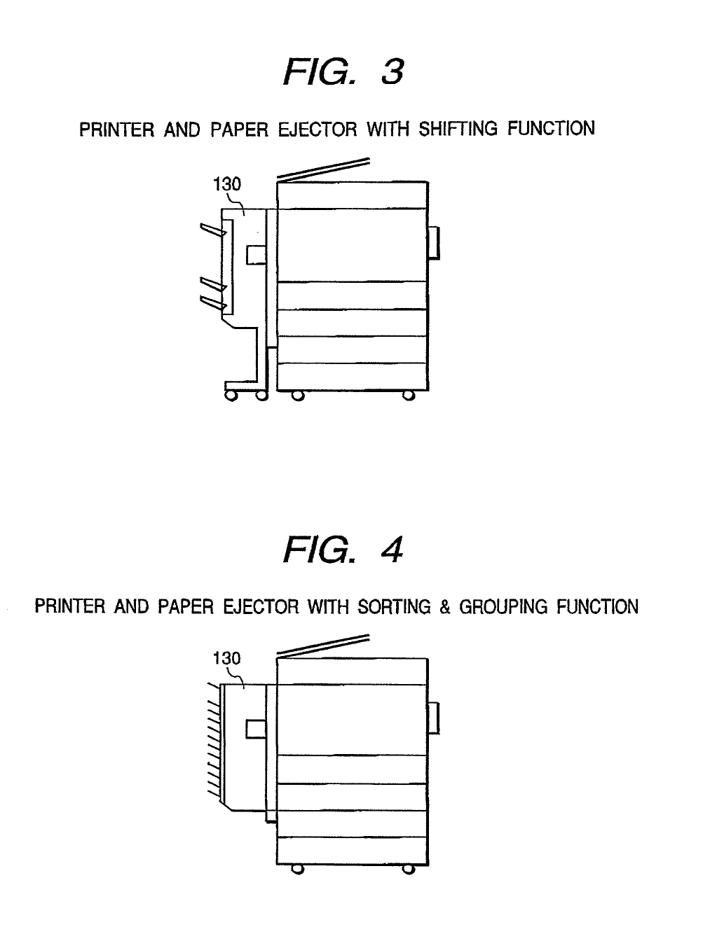

FIGS. 3 and 4 are schematic diagrams showing examples of the paper ejectors 130 shown in FIG. 1. It is now assumed that the paper ejector 130 shown in FIG. 3 has a shifting function (a function for shifting the printed sheets every number of sheets and ejecting them, a function for shifting only the first printed sheet and ejecting it) as a function of a finisher and the paper ejector 130 shown in FIG. 4 has a sorting & grouping function as a function of the finisher.

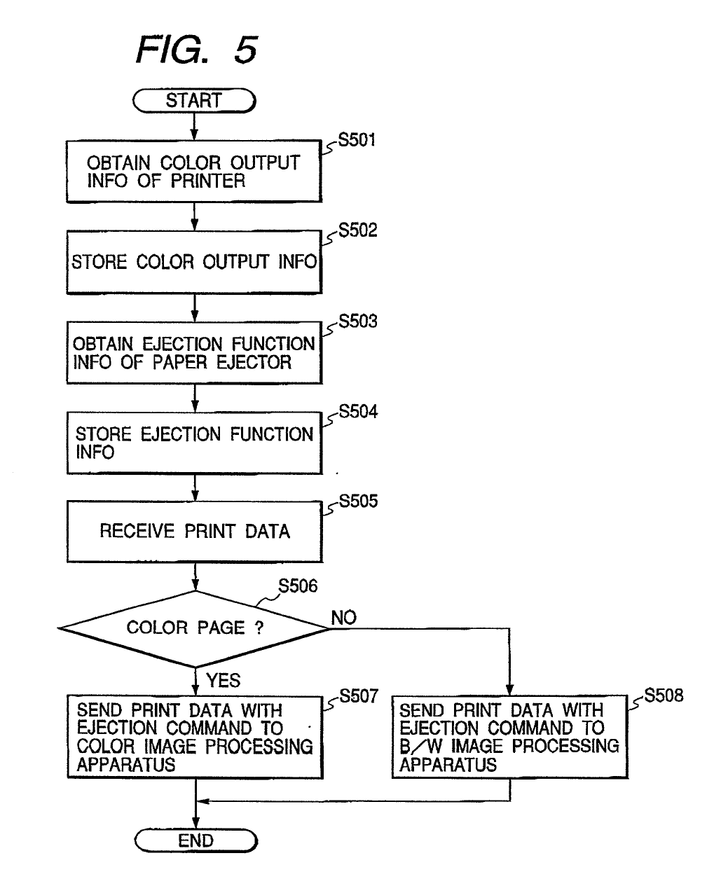

A control procedure of the print server 100 shown in FIG. 1 will now be described hereinbelow with reference to a flowchart of FIG. 5.

FIG. 5 is the flowchart showing an example of a data processing procedure in the information processing apparatus according to the invention. S501 to S508 denote processing steps

First, the print server 100 obtains color output information of the printer 120, that is, color output information regarding printer resources about whether the printer 120 and image processing apparatus 110 enable a color process or only a monochromatic (B/W) process to be executed (S501). The obtained color output information is stored in the main controller 102 in the print server 100 (S502).

Information of the ejection function of the paper ejector 130 connected to each printer 120 is obtained (S503). As already mentioned in FIGS. 3 and 4, information showing whether the finisher having the shifting function has been connected as a paper ejector 130 (the example shown in FIG. 3) or the sorter having the sorting & grouping function has been connected as a paper ejector 130 (the example shown in FIG. 4) is obtained. The obtained information of the ejection function is stored Into the main controller 102 in the print server 100 (S504).

The print data sent from the host computer 150 comprises a print server address, a host computer address, a print information header, and image information.

A user ID and an emulation ID which is used by the image information are included in the print information header. The user ID is used for specifying the user who issued a print request in the host computer 150 in the case where a plurality of users such as workstations or the like can simultaneously use the host computer 150.

The image information is print image information such as character information, bit map image information, graphics information, or the like.

Further, in the embodiment, the print information header and the image information construct a pair, and the image information handles the whole data, as one unit, responsive to one print request which is issued by the user.

Subsequently, the print data sent from the host computer 150 is received by the print server 100 through the communication controller 101 (S505). The main controller 102 analyzes the image information in the received print data and discriminates whether each page is a color page or a B/W page (S506).

If the page is determined to be a color page, an ejection command is added to the print data and the resultant data is transmitted to the image processing apparatus 110 from which the color output information has been obtained and which can perform the color process (S507). The processing routine is finished.

If the page is determined to be a B/W page in step S506, an ejection command is added to the print data and the resultant data is transmitted to the image processing apparatus 110 which can perform the B/W process (S508). The processing routine is finished.

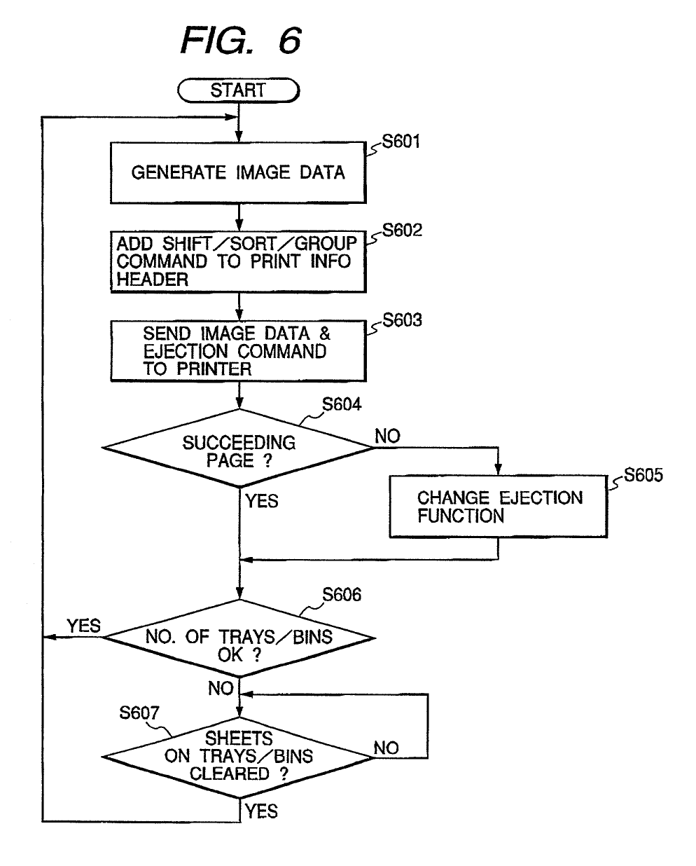

FIG. 6 is a flowchart showing an example of the data processing procedure in the image processing apparatus 110 shown In FIG. 1. S601 to S607 denote processing steps.

First, the image processing apparatus 110 generates the image data every page in accordance with the print data sent from the print server 100 (S601). When the generated image data is sent to the printer, the image processing apparatus 110 adds a command to the print information header so that the paper ejector 130 having the shifting function shifts the sheet (S602).

Similarly, a command is added so that the paper ejector 130 having the sorting & grouping function outputs the print sheets to the sort bin (S602).

The image data and the ejection command are sent to the printer 120 (S603). At this time, the image processing apparatus 110 regards the succeeding pages as one unit and sends the image data and ejection command to the printer 120.

After that, if the next page exists, whether it is a succeeding page or not is discriminated (S604). If it is determined that it is not the succeeding page, a changing process of the ejection function such that a sifting position of the finisher is changed or an output bin of the sorter is changed is executed (S605). The processing routine advances to step S606.

If it is determined in step S604 that it is the succeeding page, whether the number of pages exceeds the number of trays and the number of bins or not is discriminated by checking the information obtained from the printer 120 (S606). If it is decided that it does not exceed the number of trays and the number of bins, the processing routine is returned to step S601. If it is decided that it exceeds the number of trays and the number of bins, the apparatus waits until the sheets on the tray and bin are cleared (S607). When they have been cleared, the processing routine is returned to step S601. That is, the image processing apparatus 110 interrupts the generation and transmission of the image data to the printer 120. After it is detected that the sheets on the tray and bin have been cleared, the transmission of the image data is restarted.

As mentioned above, with respect to the pages whose succession was broken once, the shifting function of the paper ejector 130 having the shifting function is used, thereby making it easy to distinguish the unit of those pages from the previous unit.

The paper ejector 130 having the sorting & grouping function is controlled so as to output the sheets to the different bin, thereby making it easy to distinguish the unit of those pages from the previous unit.

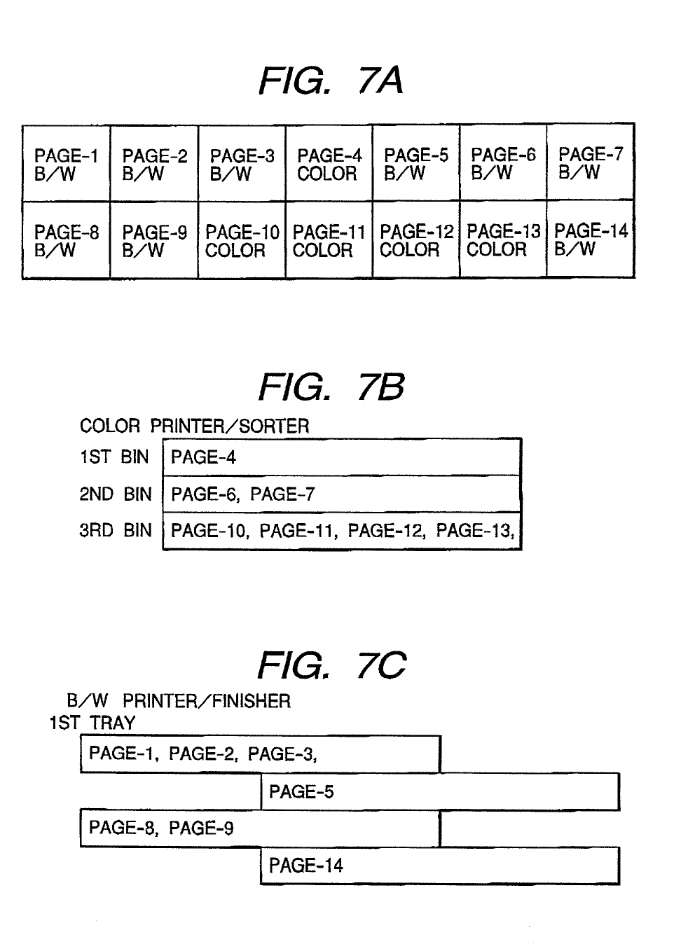

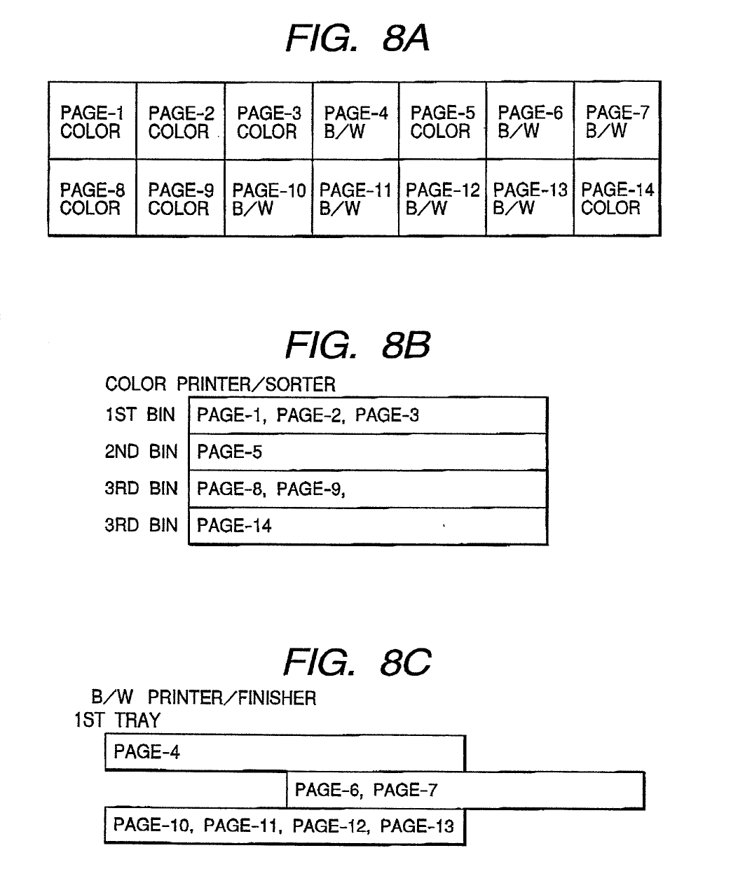

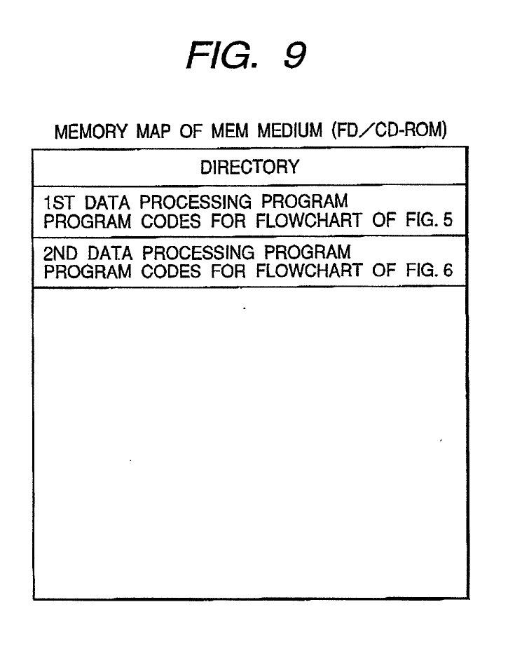

FIGS. 7A to 7C and 8A to 8C are diagrams for explaining distribution of the image data by the print server 100 shown in FIG. 1 and image output processing states by the paper ejector 130 connected to each printer 120 and correspond to a case where one printer 120 is the color printer and its paper ejector 130 is the sorter and a case where the other printer 120 is the B/W printer and its paper ejector 130 is the finisher, respectively.

FIGS. 7A and 8A show constructions of the image data of page-1 to page-14 received by the print server 100. FIGS. 7B and 8B show constructions of the pages which are ejected to each bin of the sorter of the printer. FIGS. 7C and 8C show constructions of the pages which are ejected to the tray.

Depending on the construction of the image forming system, as ejecting states by the sorter and finisher as an option function, the ejecting states of the number as many as the number of combinations of FIGS. 7B, 7C, 8B, and 8C exist.

The information of the print header can be also added in a manner such that a mode showing that the above processing procedure is used or a mode showing that the above processing procedure is not used can be selected on the print server 100.

The above adding process can be realized by providing a user interface (screen, operation panel, or the like) for the print server 100 and the user is allowed to select a desired mode.

According to the foregoing embodiment, in addition to the efficient distributing method of distributing the print data to each image processing apparatus, the technique which can sufficiently utilize the functions of the paper ejector and solve the troublesomeness of the matching and sorting of the outputted sheets can be provided, and the image forming system having excellent operability can be realized.

### Second Embodiment

In the first embodiment, the image processing apparatus 110 discriminates the succession of the page numbers of the print data received from the print server, the control command for allowing the sheets to be sorted on a page unit basis of the succeeding page numbers and ejected to the paper ejector 130 is added to the print data, and the resultant print data is outputted to the printer 120.

In the second embodiment, before the print server 100 transmits each print data to each image processing apparatus 110, the print server 100 discriminates the succession of the page numbers of each print data and inserts into each print data the control command for allowing the sheets to be sorted on an output page unit basis of the succeeding page numbers and ejected.

For example, a case where the print server 100 outputs the B/W pages in the print data to the B/W image processing apparatus and outputs the color pages to the color image processing apparatus is considered.

The print server 100 first discriminates the succession of the page numbers with respect to the B/W print data comprising the B/W pages. The print server 100 inserts into the B/W print data the control command for allowing the sheets to be sorted on an output page unit basis of the succeeding page numbers and ejected. After that, the server 100 outputs the B/W print data to the B/W image processing apparatus.

Subsequently, the print server 100 discriminates the succession of the page numbers with respect to the color print data comprising the color pages. The print server 100 inserts into the color print data the control command for allowing the sheets to be sorted on an output page unit basis of the succeeding page numbers and ejected. After that, the server 100 outputs the color print data to the color image processing apparatus.

Thus, the B/W pages and color pages which were distributed and outputted are sorted and ejected on an output page unit basis of the succeeding page numbers, respectively.

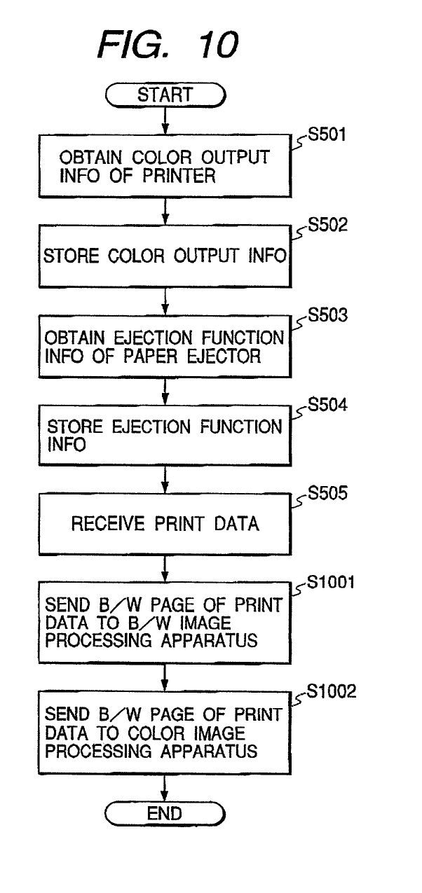

FIG. 10 is a flowchart showing the operation of the print server 100 in the second embodiment.

The operation of the print server 100 will be described hereinbelow with reference to the flowchart.

First, in steps S501 to S505, since processes similar to those in the first embodiment are executed, their description is omitted here.

In step S1001, the B/W pages of the print data received in step S505 is sent to the B/W image processing apparatus. In this instance, the control command for switching the ejecting positions regarding the pages whose succession of the page numbers was broken once is added so that the sheets are sorted and ejected on an output page unit basis of the succeeding page numbers.

In step S1002, the color pages of the print data received in step S505 is sent to the color image processing apparatus. In this instance, the control command for switching the ejecting positions regarding the pages whose succession of the page numbers was broken once is added so that the sheets are sorted and ejected on an output page unit basis of the succeeding page numbers.

As control commands which are added to the print data in steps S1001 and S1002, sorting commands using a rotation ejection function for switching the sheet ejecting direction to “portrait” or “landscape” on an output unit basis in addition to the shifting function, grouping function, or sorting function are used.

The operation of the print server 100 in the second embodiment has been described above.

On the B/W image processing apparatus side and the color image processing apparatus side, there is no need to discriminate the succession of the page numbers of the received print data, the sorting command inserted into the print data by the print server 100 is interpreted as it is by the printer 120, and the sorting and ejection are executed.

As mentioned above, in the second embodiment, since there is no need to provide any special devices for the image processing apparatus side, the image processing apparatus 110, printer 120, and paper ejector 130 can be also replaced with one general printer.

In this case, the general printer generates the image data from the print data received from the print server 100 and performs the sorting and ejection on the basis of the control command inserted by the print server 100.

A construction of a data processing program which can be read out by the image processing system to which the server apparatus and image processing apparatus according to the invention can be applied will now be described hereinbelow with reference to a memory map shown in FIG. 9.

FIG. 9 is a diagram for explaining the memory map in a memory medium for storing various processing programs which can be read out by the image processing system to which the server apparatus and image processing apparatus according to the invention can be applied.

Although not particularly shown, information for managing the programs which are stored in the memory medium, for example, version information, names of persons who made the programs, and the like are also stored. There is also a case where information depending on the OS or the like on the program reading side, for example, icons for identifying and displaying the programs, and the like are stored.

Further, data which depends on the various programs is also managed in a directory. There is also a case where a program for installing the various programs into a computer and, in the case where the program for installing has been compressed, a program for decoding it, and the like are stored.

The functions shown in FIGS. 5 and 6 in the embodiment can be also executed by the host computer by a program which is installed from the outside. In such a case, the invention is also applied to a case where information including the programs is supplied to an output apparatus from a memory medium such as CD-ROM, flash memory, FD, or the like or from an external memory medium through a network.

Naturally, the objects of the invention are also accomplished by a method whereby a memory medium in which program codes of software to realize the functions of the embodiments mentioned above have been recorded is supplied to a system or an apparatus and a computer (or a CPU or an MPU) of the system or apparatus reads out and executes the program codes stored in the memory medium.

In this case, the program codes themselves read out from the memory medium realize the novel functions of the invention, and the memory medium in which the program codes have been stored constructs the invention.

As a memory medium for supplying the program codes, for example, it is possible to use a floppy disk, a hard disk, an optical disk, a magnetooptic disk, a CD-ROM, a CD-R, a magnetic tape, a non-volatile memory card, an RON, an EEPROM, or the like.

Naturally, the invention incorporates not only a case where the functions of the embodiments mentioned above are realized by a method whereby a computer executes the read-out program codes but also a case where an OS (operating system) or the like which is operating on the computer executes a part or all of the actual processes on the basis of instructions of the program codes and the functions of the embodiments mentioned above are realized by those processes.

Further, the invention also incorporates a case where the program codes read out from the memory medium are written into a memory equipped for a function expanding board inserted into a computer or a function expanding unit connected to a computer, thereafter, a CPU or the like equipped for the function expanding board or function expanding unit executes a part or all of the actual processes on the basis of instructions of the program codes, and the functions of the embodiments mentioned above are realized by those processes.

What is claimed is:

1. An image processing apparatus for analyzing a job which is received from a server apparatus connected through a network and controlling a printer for executing a predetermined post-sheet process to an output sheet through an ejecting unit, comprising:
notifying means for notifying said server apparatus of paper ejecting process resource information and color output information for said ejecting unit in response to an inquiry from said server apparatus;
sending means for analyzing the output information and an ejection command which are received from said server apparatus and sending image data which is generated and said ejection command to said printer;
discriminating means for discriminating whether pages which are formed by said sending means are succeeding or not; and
output control means for, when it is determined by said discriminating means that the pages are succeeding, regarding said succeeding pages as one job and allowing the output pages to be outputted to a same ejection destination of said ejecting unit.

2. An apparatus according to claim 1, further comprising judging means for judging whether the number of pages which are ejected to the same ejection destination designated by said output control means exceeds the limited number of ejection pages during the output of the pages to the same ejection destination or not,
and wherein when it is determined by said judging means that the number of pages which are ejected to the same ejection destination exceeds the limited number of ejection pages, said output control means interrupts the page output and allows the pages to be ejected to a different ejection destination in said ejecting unit.

3. An apparatus according to claim 1, wherein when it is determined by said judging means that the number of pages which are ejected to the same ejection destination exceeds the limited number of ejection pages, said output control means interrupts the page output until the output page which is being ejected is removed, and at a time point when the removal of the output page which is being ejected is completed, said output control means restarts a process for ejecting the pages to a different ejection destination in said ejecting unit.

4. An apparatus according to claim 3, wherein said ejecting unit has a sorter processing function for sorting and outputting each output sheet by using a plurality of bins or a shift processing function for deviating an ejecting position of each output sheet and putting the sheets onto the same tray.

5. A data processing method in an image processing apparatus for analyzing a job which is received from a server apparatus connected through a network and controlling a printer for executing a predetermined post-sheet process to an output sheet through an ejecting unit, comprising:
a notifying step of notifying said server apparatus of paper ejecting process resource information and color output information for said ejecting unit in response to an inquiry from said server apparatus;
a sending step of analyzing the output information and an ejection command which are received from said server apparatus and sending image data which is generated and said ejection command to said printer;
a discriminating step of discriminating whether pages which are formed by said sending step are succeeding or not; and
an output control step of, when it is determined by said discriminating step that the pages are succeeding, regarding said succeeding pages as one job and allowing the output pages to be outputted to a same ejection destination of said ejecting unit.

6. A method according to claim 5, further comprising a judging step of judging whether the number of pages which are ejected to the same ejection destination designated by said output control step exceeds the limited number of ejection pages during the output of the pages to the same ejection destination or not,
and wherein when it is determined by said judging step that the number of pages which are ejected to the same ejection destination exceeds the limited number of ejection pages, in said output control step, the page output is interrupted and the pages are ejected to a different ejection destination in said ejecting unit.

7. A method according to claim 5, wherein when it is determined by said judging step that the number of pages which are ejected to the same ejection destination exceeds the limited number of ejection pages, in said output control step, the page output is interrupted until the output page which is being ejected is removed, and at a time point when the removal of the output page which is being ejected is completed, a process for ejecting the pages to a different ejection destination in said ejecting unit is restarted.

8. A method according to claim 7, wherein said ejecting unit has a sorter processing function for sorting and outputting each output sheet by using a plurality of bins or a shift processing function for deviating an ejecting position of each output sheet and putting the sheets onto the same tray.

9. A computer program which is executed by a computer of an image processing apparatus for analyzing a job which is received from a server apparatus connected through a network and controlling a printer for executing a predetermined post-sheet process to an output sheet through an ejecting unit, comprising:
a notifying step of notifying said server apparatus of paper ejecting process resource information and color output information for said ejecting unit in response to an inquiry from said server apparatus;
a sending step of analyzing the output information and an ejection command which are received from said server apparatus and sending image data which is generated and said ejection command to said printer;
a discriminating stop of discriminating whether pages which are formed by said sending step are succeeding or not; and
an output control step of, when it is determined by said discriminating step that the pages are succeeding, regarding said succeeding pages as one job and allowing the output pages to be outputted to a same ejection destination of said ejecting unit.

10. A computer-readable memory medium which stores the computer program according to claim 9.

11. An information processing apparatus connected to a first printer and a second printer, comprising:
discriminating means for discriminating to which of said first printer and said second printer each page of print information is outputted;
output means for outputting the page in said print information which was determined to be outputted to said first printer to said first printer and outputting the page in said print information which was determined to be outputted to said second printer to said second printer; and
control means for adding control information for switching ejecting positions regarding the pages in which succession of page numbers was broken to the print information which is outputted to said first printer by said output means in a manner such that the pages are sorted and ejected on an output page unit basis of the succeeding page numbers in said first printer.

12. An apparatus according to claim 11, wherein said control means further adds control information for switching ejecting positions regarding the pages in which succession of page numbers was broken to the print information which is outputted to said second printer by said output means in a manner such that the pages are sorted and ejected on an output page unit basis of the succeeding page numbers in said second printer.

13. An apparatus according to claim 11, wherein said control means further adds said control information in accordance with the sorting function which said first printer has.

14. An apparatus according to claim 13, wherein said control information is control information for instructing a sorter processing function for sorting and outputting each output sheet by using a plurality of bins.

15. An apparatus according to claim 13, wherein said control information is control information for instructing a shift processing function for deviating the ejecting position of each output sheet and putting the sheets onto a same tray.

16. An apparatus according to claim 13, wherein said control information is control information for instructing a rotation ejection function for switching an ejecting direction of sheets either to a portrait direction or a landscape direction.

17. An apparatus according to claim 11, wherein said discriminating means discriminates to which of said fist printer and said second printer each page of the print information should be outputted in accordance with whether information to be color printed exists in each page of the print information or not.

18. An apparatus according to claim 17, wherein said first printer is a monochromatic printer and said second printer is a color printer.

19. A print information outputting method comprising:
a discriminating step of discriminating to which of a first printer and a second printer each page of print information is outputted;
an output step of outputting the page in said print information which was determined to be outputted to said first printer to said first printer and outputting the page in said print information which was determined to be outputted to said second printer to said second printer; and
a control step of adding control information for switching ejecting positions regarding the pages in which succession of page numbers was broken to the print information which is outputted to said first printer by said output step in a manner such that the pages are sorted and ejected on an output page unit basis of the succeeding page numbers in said first printer.

20. A method according to claim 19, wherein in said control step, control information for switching ejecting positions regarding the pages in which succession of page numbers was broken is further added to the print information which is outputted to said second printer by said output step in a manner such that the pages are sorted and ejected on an output page unit basis of the succeeding page numbers in said second printer.

21. A method according to claim 19, wherein in said control step, said control information is added in accordance with the sorting function which said first printer has.

22. A method according to claim 21, wherein said control information is control information for instructing a sorter processing function for sorting and outputting each output sheet by using a plurality of bins.

23. A method according to claim 21, wherein said control information is control information for instructing a shift processing function for deviating the ejecting position of each output sheet and putting the sheets onto a same tray.

24. A method according to claim 21, wherein said control information is control information for instructing a rotation ejection function for switching an ejecting direction of sheets either to a portrait direction or a landscape direction.

25. A method according to claim 19, wherein in said discriminating step, to which of said fist printer and said second printer each page of the print information should be outputted is discriminated in accordance with whether information to be color printed exists in each page of the print information or not.

26. A method according to claim 25, wherein said first printer is a monochromatic printer and said second printer is a color printer.

27. A computer program which is executed by a computer of an information processing apparatus connected to a first printer and a second printer, comprising:
a discriminating step of discriminating to which of said first printer and said second printer each page of print information is outputted;
an output step of outputting the page in said print information which was determined to be outputted to said first printer to said first printer and outputting the page in said print information which was determined to be outputted to said second printer to said second printer: and
a control step of adding control information for switching ejecting positions regarding the pages in which succession of page numbers was broken to the print information which is outputted to said first printer by said output step in a manner such that the pages are sorted and ejected on an output page unit basis of the succeeding page numbers in said first printer.

28. A computer-readable memory medium which stores the computer program according to claim 27.
